(19) United States
(12) Patent Application Publication
(10) Pub. No.: US 2011/0015983 A1
(43) Pub. Date: Jan. 20, 2011

(54) Method and System for Reliable and Fast Mobile Marketing

(76) Inventor: Pierre Bonnat, Las Vegas, NV (US)

Correspondence Address: MCANDREWS HELD & MALLOY, LTD, 500 WEST MADISON STREET, SUITE 3400, CHICAGO, IL, 60661, US

(21) Appl. No.: 12/839,119

(22) Filed: Jul. 19, 2010

Related U.S. Application Data
(60) Provisional application No. 61/226,578, filed on Jul. 17, 2009.

(51) Int. Cl. G06Q 30/00

(52) U.S. Cl. 705/14.26

(57) ABSTRACT

Aspects of a method and system for reliable and fast mobile marketing are provided. In this regard, a mobile marketing device may redeem at a point of sales, one or more coupons that are received by a user device. The mobile marketing device may verify the redeemed one or more coupons based on a generated secure unique code corresponding to each of the redeemed one or more coupons. The mobile marketing device may schedule payment associated with a monetary value of each of the redeemed one or more coupons to a retailer based on the verification of the redeemed one or more coupons with the generated secure unique code.

CROSS-REFERENCE TO RELATED APPLICATIONS/INCORPORATION BY REFERENCE

This application makes reference to, claims priority to, and claims benefit of U.S. Provisional Application Ser. No. 61/226,578, filed Jul. 17, 2009.

The above referenced application is hereby incorporated herein by reference in its entirety.

### FIELD OF THE INVENTION

Certain embodiments of the invention relate to mobile marketing. More specifically, certain embodiments of the invention relate to a method and system for reliable and fast mobile marketing.

### BACKGROUND OF THE INVENTION

Mobile communications have changed the way people communicate and mobile phones have been transformed from a luxury item to an essential part of every day life. The use of mobile phones is today dictated by social situations, rather than hampered by location or technology.

While voice connections fulfill the basic need to communicate, and mobile voice connections continue to filter even further into the fabric of every day life, the mobile access to services via the Internet has become the next step in the mobile communication revolution. Currently, most mobile devices are equipped with a user interface that allows users to access the services provided via the Internet. For example, some mobile devices may have browsers, and software and/or hardware buttons may be provided to enable navigation and/or control of the user interface. Some mobile devices such as smartphones are equipped with touch screen capability that allows users to navigate or control the user interface via touching with one hand while the device is held in another hand.

The use of mobile handsets and smartphones in e-commerce has been rapidly increasing over the years. A mobile storefront may make it easy and convenient for customers to make a purchase whenever they want, and it may allow a more streamlined payment process that may be better suited to buying on the fly.

In one scenario, a cashier may accept a coupon at a retailer's point of sales. The retailer may mail the coupons it collects to a retail clearinghouse, which may sort through millions of coupons, for example, largely by hand, to separate them by manufacturer. The retail clearinghouse may send the sorted coupons with an invoice to the corresponding manufacturer or its agent. The manufacturer or its agent may verify the coupons submitted and reimburse the retail clearinghouse for the monetary value of the coupons, and the retailer may receive a payment from the retail clearinghouse. The manufacturer may also reimburse the retailer for processing coupons. This cycle may consume between a few weeks and over a month, and is archaic, unreliable, and may involve tedious manual handling.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for reliable and fast mobile marketing, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary mobile marketing system for reliable and fast mobile marketing, in accordance with an embodiment of the invention.

FIG. 2 is a diagram illustrating an exemplary user device that may be controlled via a sectional user interface, in accordance with an embodiment of the invention.

FIG. 3 is a diagram illustrating launching a mobile application via a user interface for reliable and fast mobile marketing, in accordance with an embodiment of the invention.

FIG. 4 is a flow diagram illustrating exemplary steps for reliable and fast mobile marketing, in accordance with an embodiment of the invention.

### DETAILED DESCRIPTION OF THE INVENTION

Certain embodiments of the invention may be found in a method and system for reliable and fast mobile marketing. In this regard, a mobile marketing device may redeem at a point of sales, one or more coupons that are received by a user device. The coupons may be referred to as vouchers, sweepstakes, promotional codes, key codes, cashier rebate, and/or discount barcodes, for example. The coupons may be tickets, for example, that users may exchange for a financial discount and/or a rebate when purchasing a product from a retailer. A coupon may have a monetary value and may be worth cash money, to be paid to the retailer or retail channel by the coupon manufacturer.

The mobile marketing device may verify the redeemed one or more coupons based on a generated secure unique code corresponding to each of the redeemed one or more coupons. The mobile marketing device may schedule payment associated with a monetary value of each of the redeemed one or more coupons to a retailer based on the verification of the redeemed one or more coupons with the generated secure unique code.

In accordance with an embodiment of the invention, a mobile couponing solution may be provided that may dramatically reduce coupon redemption process time, errors and/or handle end-to-end transactions via a unified system that may be easy to deploy and may not need additional equipment.

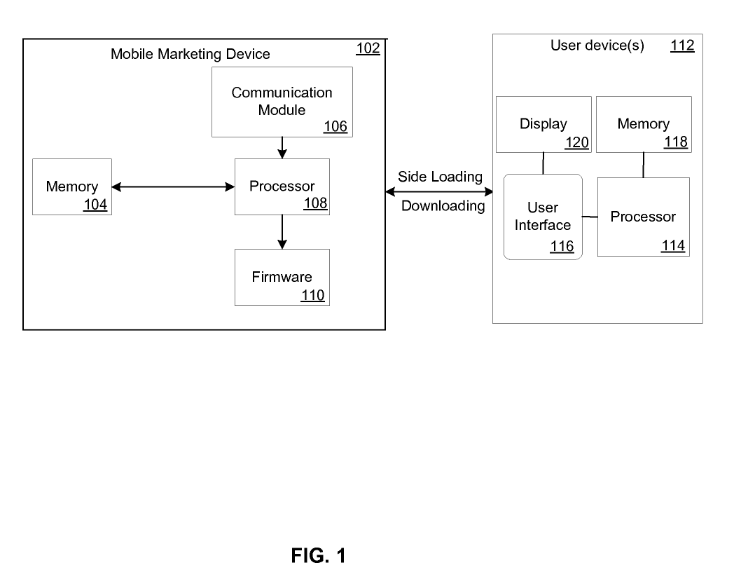

FIG. 1 is a block diagram of an exemplary mobile marketing system for reliable and fast mobile marketing, in accordance with an embodiment of the invention. Referring to FIG. 1, there is shown a mobile marketing device 102 and a user device 112. The user device 112 may be, for example, a multimedia device, a cellphone, a smartphone, a dataphone, a PC, a laptop or a notebook computer, and/or a display device. The mobile marketing device 102 may comprise a memory 104, a communication module 106, a processor 108, and firmware 110. The mobile marketing device 102 may comprise suitable logic, circuitry, interfaces, and/or code, and may be wired and/or wirelessly connected to the user device 112 for loading of information via, for example, loading via a peer-to-peer connection, a network connection, and/or by wired and/or wireless communication.

The mobile marketing device 102 may be enabled to function as a point of access to information on the Internet. The mobile marketing device 102 may be, for example, a site that may be enabled to provide a single function via a web page or site. The mobile marketing device 102 may present information from diverse sources in a unified way such as e-mail, news, stock prices, infotainment and various other features. The mobile marketing device 102 may be enabled to store a structured collection of records or data, for example. The mobile marketing device 102 may be enabled to utilize software to organize the storage of data.

The communication module 106 may comprise suitable logic, circuitry, interfaces, and/or code that may be operable to receive one or more coupons from a manufacturer and communicate the received one or more coupons to the user device 112 via a wired and/or a wireless signal. The communication module 106 may be operable to communicate one or more secure unique codes corresponding to each of the received coupons from the manufacturer to the user device 112 via a mobile application. The communication module 106 may support a plurality of interfaces. For example, the communication module 106 may support a Bluetooth interface, a ZigBee interface, an IrDA interface, and/or a wireless USB (W-USB) interface.

The processor 108 may comprise suitable logic, circuitry, interfaces, and/or code that may be operable to utilize the received one or more coupons from the manufacturer and generate a secure unique code for each of the received one or more coupons.

The memory 104 may comprise suitable logic, circuitry, interfaces, and/or code that may be operable to store one or more of the received coupons from the manufacturer, the generated secure unique codes corresponding to each of the received coupons, and/or a user's credentials, for example, a username, a password, a name, a telephone number, an email address, a date of birth, and/or any other identification parameters.

The firmware 110 may comprise a plurality of drivers and operating system (OS) libraries to convert received signals into functional commands. The firmware 110 may be enabled to map local functions, and convert received signals into compatible data, such as user customization features, applets, and/or plugins to control the mobile marketing device 102.

The user device 112 may be operable to access content directly from the mobile marketing device 102 rather than from a carrier network, for example. This method of uploading and/or downloading customized information directly from the mobile marketing device 102 rather than from the carrier network may be referred to as side loading.

The user device 112 may comprise a processor 114, a user interface 116, a memory 118, and a display 120. In this regard, data may be transferred from the mobile marketing device 102 to the user device 112, such as a cellphone, smartphone, and/or a dataphone, and this data may be associated or mapped to media content that may be remotely accessed by the cellphone, smartphone, and/or dataphone via a service provider such as a cellular or PCS service provider. The transferred data that is associated or mapped to media content may be utilized to customize the user interface 116.

The processor 114 may comprise suitable logic, circuitry, interfaces, and/or code that may be operable to download or sideload a mobile application from the mobile marketing device 102 based on verification of a user's credentials, for example, a username and a password.

The memory 118 may comprise suitable logic, circuitry, interfaces, and/or code that may be operable to store one or more of the received coupons from the mobile marketing device 102, and/or a user's credentials, for example, a username, a password, a name, a telephone number, an email address, a date of birth, and/or any other identification parameters.

The display 120 may comprise suitable logic, circuitry, interfaces, and/or code that may be operable to display the received one or more coupons from the mobile marketing device 102.

The user interface 116 may comprise suitable logic, circuitry, interfaces, and/or code that may be operable to be created, modified and/or organized by a user. In this regard, the user may choose, select, create, arrange, manipulate and/or organize content to be utilized for the user interface 116 and/or one or more content components. For example, the user may organize the content components on a screen and may choose content such as personal photographs for background and/or icon images. In addition, the user may create and/or modify the way content components are activated or presented to the user. For example, the user may make, import and/or edit icons and/or backgrounds for the user interface 116. Accordingly, the user may associate and/or map the icon to a function so that the user may enable or activate a function via the icon. Exemplary icons may enable functions such as hyper-links, bookmarks, programs, applications, shortcuts, widgets, really simple syndication (RSS) feeds or markup language feeds or information, and/or favorite buddies.

In operation, the mobile marketing device 102 may be operable to receive one or more coupons from a manufacturer, and generate one or more secure unique codes corresponding to each of the received one or more coupons. The user device 112 may be operable to receive a user's credentials, for example, a username and a password, and communicate the user's credentials to the mobile marketing device 102. The mobile marketing device 102 may be operable to verify the received user's credentials based on the user's credentials that were previously stored in the user account at the time of creation of the user's account.

The user device 112 may be operable to receive and display the coupons from the mobile marketing device 102 based on verification of the user's credentials. The mobile marketing device 102 may be operable to redeem the coupon at a point of sales, for example, a retailer. The mobile marketing device 102 may be operable to communicate the redeemed coupon and the corresponding generated secure unique code to the retailer.

The user device 112 may be operable to receive the generated secure unique code from the retailer, and a user may enter the secure unique code in a mobile application field corresponding to the redeemed coupon. The mobile marketing device 102 may be operable to verify the entered secure unique code and the corresponding coupon and schedule payment associated with a monetary value of the coupon based on the verification of the received coupon with the generated secure unique code.

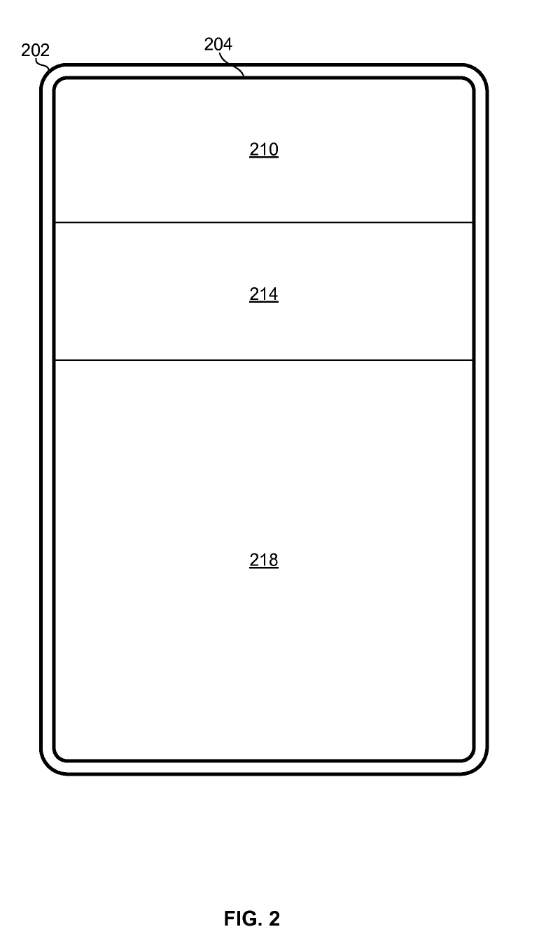

FIG. 2 is a diagram illustrating an exemplary user device that may be controlled via a sectional user interface, in accordance with an embodiment of the invention. Referring to FIG. 2, there is shown a user device 202 comprising a touchscreen display 204. In this regard, although a touchscreen display is utilized for illustration, the user device 202 may comprise a non-touchscreen display and one or more input devices such as a trackball, one or more multi-function buttons, and/or a keyboard, without deviating from the scope of the present invention.

The user device 202 may comprise a user interface, such as a graphical user interface (GUI), which may enable a user to navigate through and launch various applications and/or functions on the user device 202. In this regard, the user interface may enable interacting with the user device 202 via respiratory inputs such as exhalations, tactual inputs such as button presses, audio actions such as voice commands, and/or movements of the user device 202 such as those detected by an accelerometer and/or gyroscope. In this regard, the user interface may enable interacting with the user device 202 via any combination of one or more of the input methods. Furthermore, the user interface may be enabled to detect an error and/or failure of one or more input methods and default to one or more other input methods. In this manner, interacting with the user interface may not be critically impacted by the failure and/or absence of a particular input method.

The user interface of the user device 202 may display information about the status and/or capabilities of the user device 202 and/or display information and/or content generated by one or more applications on the user device 202. In various embodiments of the invention, upon powering on the user device 202, a homescreen of the user interface may be displayed or presented. In various embodiments of the invention, the user device 202 may comprise, for example, one or more of a cellular telephone, a smartphone, a wireless telephone, a notebook computer, a personal media player, a personal digital assistant, a multimedia device, a handheld device and/or a multi-function mobile device.

The user interface may be sectioned into one or more of a fixed region 210 comprising one or more fixed zones, a control region 214 comprising one or more control zones, and a content region 218 comprising one or more content zones. In this regard, each of the regions 210, 214, and 218, when present, may be of any size and/or shape and may be in any location(s) of the display 204. Moreover, the presence, size, shape, and location(s) of the regions 210, 214, and 218 may be configured, personalized or customized by a user of the user device 202. For example, the user device 202 may comprise a user interface customization application which a user may run to configure the regions of the user interface based on preferences such as whether the user is right handed or left handed.

The fixed region 210 may display information independent of a state of and/or activity in the control region 214. Exemplary information that may be displayed in the fixed region 210 may comprise the day, the time, weather, appointments in a calendar, RSS (or XML, or other markup language) feeds, recent email contacts, and/or recent phone contacts. However, the preceding are just examples of information that may be displayed in the fixed region 210 and the invention may not be so limited. Additionally, the size, shape and/or location of the fixed region 210 may change depending on what functions and/or applications are running on the user device 202. Furthermore, the type and/or amount of information displayed in the fixed region 210 may be customized by a user of the user device 202.

The control region 214 may enable controlling the user device 202 such that desired information may be displayed and/or desired applications and/or functions may be launched on the user device 202. In this regard, voice, respiratory and/or tactual input may be utilized to scroll, select, manipulate, or otherwise affect objects, such as text, images, links, and/or icons, of the user interface. Additionally, the type and/or amount of information displayed in the control region 214 may be customized by a user of the user device 202. Furthermore, the size, shape and/or location of the control region 214 may change depending on what functions and/or applications are running on the user device 202.

The content region 218 may display information that may depend on a state of and/or activity in the control region 214. For example, the information in the content region 218 may depend on an active icon in the control region. In this regard, an active icon may be an icon which has been navigated to (via voice, breath and/or tactual input) but has not been selected via a “click” (e.g., a tap on a touch screen, a button press or a puff of air). In one exemplary embodiment of the invention, the active icon may be link to a website and the content region 218 may display RSS feeds from that website. In another exemplary embodiment of the invention, the active icon may be a shortcut to launch an email client and the content region 218 may display one or more recent email messages. In this regard, exemplary information displayed in the content region 218 may comprise RSS or XML feeds, images, a calendar, recent calls, recent texts, and/or recent emails. However, the preceding are just examples and the invention is not so limited. Additionally, the information displayed in the content region 218 may be customizable by a user of the user device 202. Furthermore, the size, shape and/or location of the content region 218 may change depending on what functions and/or applications are running on the user device 202.

Information in the fixed region 210 and/or the content region 218 may be displayed in the form of one or more objects, such as images, text, links and/or icons. In various embodiments of the invention, objects in the fixed region 210 and/or the content region 218 may be selectable via tactual and/or respiratory input. However, the response of the fixed region 210 and/or the content region 218 may be limited, as described above, to prevent inadvertent clicks. Additionally, in various embodiments of the invention, objects in the content region 218 may be scrolled into the control region 214 such that they may become selectable. For example, voice or respiratory input may be utilized to scroll objects from the content region 218 into the control region 214 such that the object may be selected via tactual input to the control region 210.

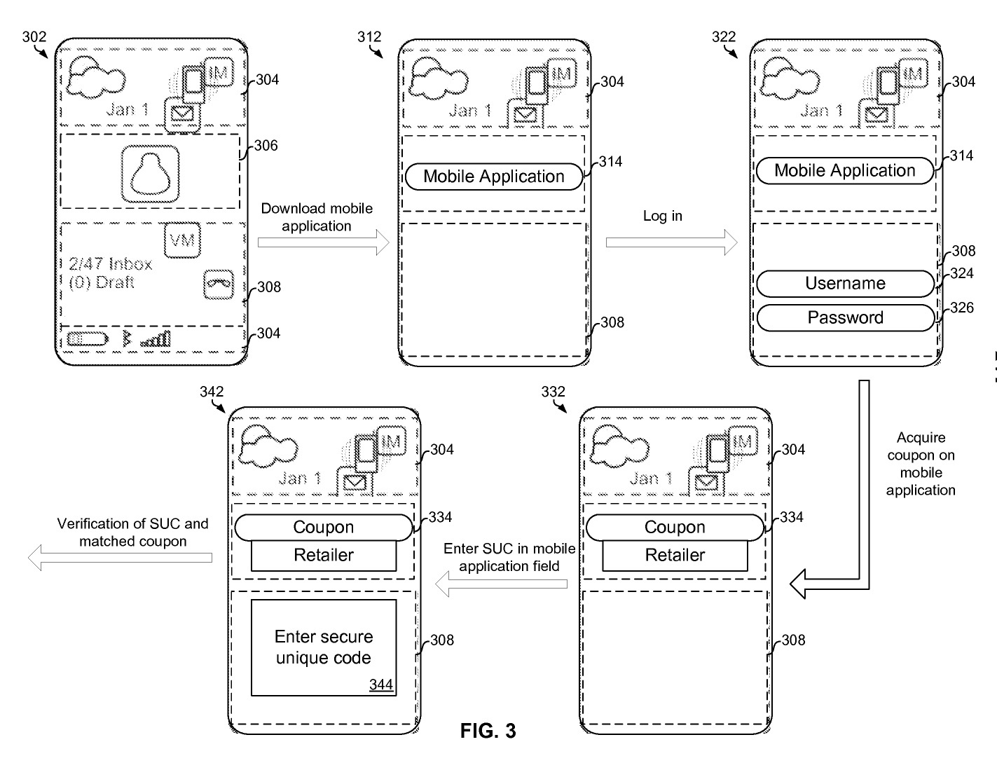

FIG. 3 is a diagram illustrating launching a mobile application via a user interface for reliable and fast mobile marketing, in accordance with an embodiment of the invention. Referring to FIG. 3 there is shown exemplary screen shots 302, 312, 322, 332, of the user device 112, which depict an exemplary sequence of actions for fast and reliable mobile marketing.

The screenshot 302 depicts a fixed zone 304 comprising weather, date information, battery information, and carrier signal strength indication, a control zone 306 corresponding to an object for downloading a mobile application, and a content zone 308 comprising objects corresponding to email and/or voice mail. Subsequent to a user downloading the mobile application, the user device 202 may display a screenshot that may be similar to screenshot 312, for example.

The screenshot 312 depicts a fixed zone 304 comprising weather, date information, battery information, and carrier signal strength indication, a control zone 306 corresponding to an object for launching the downloaded mobile application 314, and a content zone 308. Subsequent to a user launching the downloaded mobile application 314, the user device 202 may display a screenshot that may be similar to screenshot 322, for example.

The screenshot 322 depicts a fixed zone 304 comprising weather, date information, battery information, and carrier signal strength indication, a control zone 306 corresponding to an object for the launched mobile application 314, and a content zone 308 comprising a username field 324 and a password field 326 for the launched mobile application 314. A user may enter a username in the username field 324 and a corresponding password in the password field 326. The mobile marketing device 102 may be operable to verify the entered user's credentials, and the user device 202 may display a screenshot that may be similar to screenshot 332, for example

The screenshot 332 depicts a fixed zone 304 comprising weather, date information, battery information, and carrier signal strength indication, a control zone 306 comprising a coupon 334 associated with a retailer, and a content zone 308. A user may redeem the coupon 334 at a point of sales, for example, the retailer. The mobile marketing device 102 may be operable to communicate the redeemed coupon and a corresponding generated secure unique code to the retailer. The user device 112 may be operable to receive the generated secure unique code from the retailer, and the user device 202 may display a screenshot that may be similar to screenshot 342, for example.

The screenshot 342 depicts a fixed zone 304 comprising weather, date information, battery information, and carrier signal strength indication, a control zone 306 comprising a coupon 334 associated with a retailer, and a content zone 308 comprising a secure unique code field 344. A user may enter the received secure unique code from the retailer corresponding to the redeemed coupon. The mobile marketing device 102 may be operable to verify the entered secure unique code and the corresponding coupon and schedule payment associated with a monetary value of the coupons based on the verification of the received coupon with the generated secure unique code.

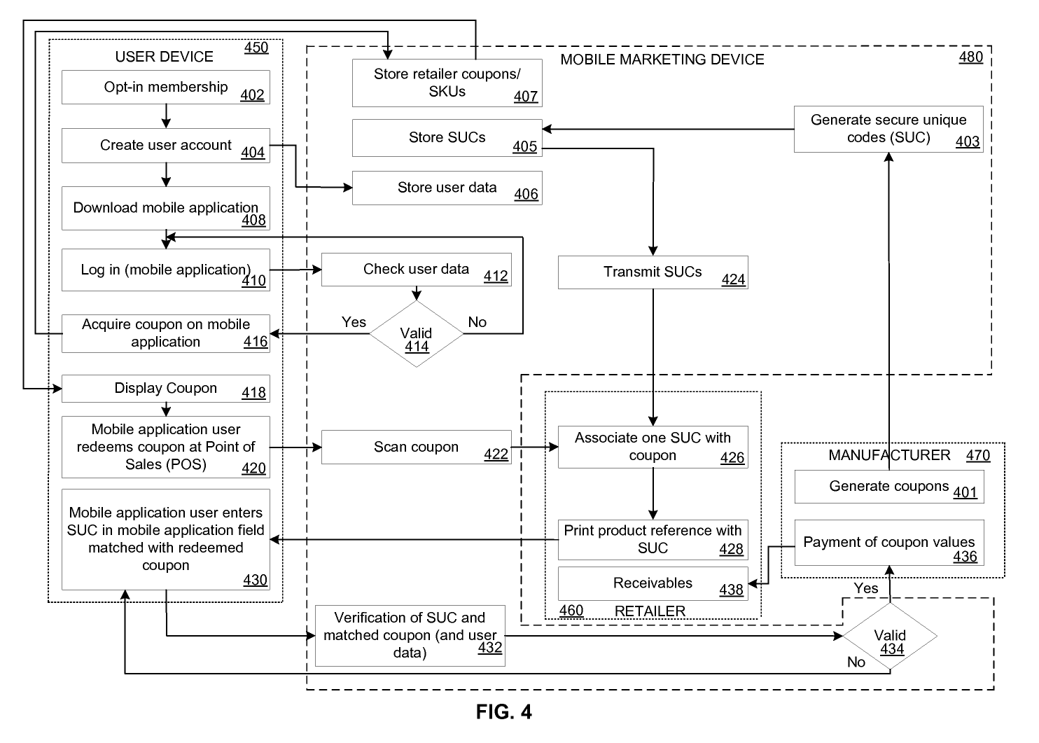

FIG. 4 is a flow diagram illustrating exemplary steps for reliable and fast mobile marketing, in accordance with an embodiment of the invention. Referring to FIG. 4, there is shown a user device 450, a retailer 460, a manufacturer 470, and a mobile marketing device 480.

In step 401, the manufacturer 470 may generate a plurality of coupons and communicate the generated coupons to the mobile marketing device 480. In step 403, the mobile marketing device 480 may be operable to generate a secure unique code for each of the received coupons from the manufacturer 470. In step 405, the mobile marketing device 480 may be operable to store the generated secure unique codes corresponding to each of the received coupons from the manufacturer 470. In step 407, the mobile marketing device 480 may be operable to store the received coupons and corresponding product identification numbers, for example, stock-keeping unit (SKU) numbers.

In step 402, a user may opt to join as a member of a service in order to receive coupons and/or discounts corresponding to one or more products from a retailer. In step 404, a user may create a user account on the user device 450 by entering one or more credentials, for example, a username, a password, a name, a telephone number, an email address, a date of birth, and/or any other identification parameters to enable unique identification of the user. In step 406, the mobile marketing device 480 may be operable to store the user's credentials. The user account data may be updated from the user device 450, for example, a cellphone, smartphone, a dataphone, a personal computer via a website, for example.

In step 408, the user may be prompted to download, sideload, or use any other delivery means to receive a mobile application via the user device 450. In step 410, after downloading the mobile application, a user may log-in to the mobile application using the user's credentials, for example, a username, a password, a name, a telephone number, an email address, a date of birth, and/or any other identification parameters. In accordance with an embodiment of the invention, the mobile marketing device 480 may be operable to encrypt data, for example, coupons, secure unique codes, and/or user credentials and communicate the encrypted data to the user device 450, the retailer 460, and/or the manufacturer 470 via one or more wireless networks, for example.

In step 412, the mobile marketing device 480 may be operable to check the entered user's credentials based on the user's credentials stored at the time of creation of the user's account. In step 414, the mobile marketing device 480 may be operable to determine whether the entered user's credentials are valid. In instances where the entered user's credentials are not valid, control returns to step 410. In instances where the entered user's credentials are valid, control passes to step 416.

In step 416, the user device 450 may be operable to acquire a coupon from the mobile marketing device 480 via the mobile application. For example, a user may be enabled to enter into sweepstakes, play games, answer quizzes, make donations, volunteer, participate in contests, and/or participate in loyalty programs and/or incentive-based programs, in order to acquire one or more coupons from the mobile marketing device 480 via the mobile application.

In step 418, the user device 450 may be operable to display the received coupon, for example, as pictures, text, and/or XML feeds. In step 420, a user may present for redemption, the coupon displayed by the user device 450 at a point of sales. In step 422, the mobile marketing device 480 may be operable to scan the coupon in order to redeem the coupon.

In accordance with an embodiment of the invention, a user may use one or more interaction methods, for example, scrolling and/or touch-to-pan, to enable the user to search, call and/or display any coupon acquired to a cashier at the retailer's point of sales. The user may also be enabled to scan the coupon via automated self check-out systems at the point of sales, or to enter a key code in a website's check-out page in order to redeem the coupons.

In accordance with another embodiment of the invention, the coupons may not be stored in the user device 450. The mobile marketing device 480 may enable a user to view a list of coupons and their corresponding expiration dates, acquired via the mobile application. The user device 450 may be operable to temporarily store the coupons, and enable a user to select, click, tap, or use any other interaction method to access the coupon on the user device 450. The coupon may be deleted from the user device 450 after a certain period of time. After the expiration date, a user may not be able to receive the coupon from the mobile marketing device 480. The mobile marketing device 480 may be operable to mark a coupon as used after redemption in order to prevent a user from using the coupon subsequently.

In step 424, the mobile marketing device 480 may be operable to communicate a stored generated secure unique code corresponding to the scanned redeemed coupon to the retailer 460. In accordance with another embodiment of the invention, the mobile marketing device 480 may be operable to generate and communicate the secure unique codes to the retailer 460 in real time or communicate the secure unique codes periodically to the retailer's 460 server and/or database systems.

In step 426, the retailer 460 may be operable to associate the redeemed coupon with the received secure unique code corresponding to the redeemed coupon. In step 428, the retailer 460 may generate a product reference corresponding to the redeemed coupon and the corresponding secure unique code on the invoice. In accordance with another embodiment of the invention, the retailer 460 may communicate the corresponding secure unique code to the user device 450, for example, as a weekly list. In step 430, a user may enter in the user device 450, the secure unique code corresponding to the redeemed coupon received from the retailer 460. In accordance with another embodiment of the invention, the coupon may comprise a unique identification corresponding to the user, for example, a username. The user may be enabled to enter the secure unique code in the mobile application, or on a website, for example.

In step 432, the mobile marketing device 480 may be operable to verify the entered secure unique code corresponding to the redeemed coupon. In step 434, the mobile marketing device 480 may be operable to determine whether the entered secure unique code corresponding to the redeemed coupon is valid. In instances where the entered secure unique code corresponding to the redeemed coupon is not valid, control returns to step 430. In instances where the entered secure unique code corresponding to the redeemed coupon is valid, control passes to step 436.

In accordance with another embodiment of the invention, the mobile marketing device 480 may be operable to store a plurality of parameters corresponding to coupon acquisition and redemption for each transaction. For example, the mobile marketing device 480 may be operable to store the date and time a coupon was acquired by the user device 450, duration of the transaction, interaction with the mobile application, and/or a date and time of redemption of the coupon by the user device 450.

In step 436, the mobile marketing device 480 may be operable to schedule payment associated with a monetary value of the redeemed coupon by the manufacturer 470. In step 438, the retailer 460 may receive the scheduled payment associated with the monetary value of the redeemed coupon from the manufacturer 470.

In accordance with another embodiment of the invention, a method and system for reliable and fast mobile marketing may ensure systematic and proper entry of the secure unique code in the mobile application by users. For example, when a user downloads more than a particular number of coupons, but does not use or redeem a particular number of downloaded coupons, the mobile marketing device 480 may be operable to disable and/or suspend the user's account. Accordingly, the mobile marketing device 480 may be operable to define a maximum allowed threshold for the percentage of redeemed coupons compared to the number of acquired coupons. For example, the mobile marketing device 480 may be operable to restrict a user to enter a secure unique code for a downloaded coupon before downloading another coupon. The mobile marketing device 480 may be operable to manage and/or monitor the monetary value associated with each coupon, and/or set periodic limits on downloading and/or redeeming coupons, for example. The mobile marketing device 480 may be operable to grant points or incentives to a user for each entered secure unique code via loyalty programs, provide additional discounts for accumulating points above a certain threshold, for example.

Aspects of a method and system for reliable and fast mobile marketing are provided. In this regard, one or more processors and/or circuits for use in a mobile marketing device 102 (FIG. 1) may be operable to redeem at a point of sales, for example, a retailer 460 (FIG. 4), one or more coupons, for example, coupon 334 (FIG. 3) that are received by a user device 112 (FIG. 1). The mobile marketing device 102 may be operable to verify the redeemed one or more coupons, for example, coupon 334 based on a generated secure unique code, for example, secure unique code 344 (FIG. 3) corresponding to each of the redeemed one or more coupons, for example, coupon 334. The mobile marketing device 102 may be operable to schedule payment associated with a monetary value of each of the redeemed one or more coupons, for example, coupon 334 based on the verification of the redeemed one or more coupons, for example, coupon 334 with the generated secure unique code, for example, secure unique code 344. The mobile marketing device 102 may be operable to generate one or more secure unique codes, for example, secure unique code 344 for each of the coupons, for example, coupon 334 received from a manufacturer 470 (FIG. 4).

The mobile marketing device 102 may be operable to store in its memory 104 (FIG. 1), one or more of the received coupons, for example, coupon 334 from the manufacturer 470, the generated one or more secure unique codes, for example, secure unique code 344 corresponding to each of the received coupons, for example, coupon 334 from the manufacturer 470, and/or a user's credentials, for example, a username 324 (FIG. 3) and/or a password 326 (FIG. 3). The mobile marketing device 102 may be operable to verify the stored user's credentials, for example, a username 324 and/or a password 326 prior to communicating one or more coupons, for example, coupon 334 to the user device 112.

The mobile marketing device 102 may be operable to communicate the one or more coupons, for example, coupon 334 to the user device 112 via the mobile application 314 (FIG. 3) based on the verification of the stored user's credentials, for example, a username 324 and a password 326. The mobile marketing device 102 may be operable to communicate the stored generated one or more secure unique codes, for example, secure unique code 344 corresponding to each of the coupons, for example, coupon 334 received from the manufacturer 470 to a retailer 460 associated with the point of sales. The retailer 460 may associate the redeemed one or more coupons, for example, coupon 334 with a corresponding one of the communicated stored generated one or more secure unique codes, for example, secure unique code 344. The mobile marketing device 102 may be operable to manage delivery of the one or more coupons, for example, coupon 334 to the user device 112 based on one or more of a number of the one or more coupons redeemed, for example, coupon 334, an expiration date of the one or more coupons, for example, coupon 334, and/or a number of the generated one or more secure unique codes, for example, secure unique code 344 entered at the user device 112.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for reliable and fast mobile marketing.

Accordingly, the present invention may be realized in hardware, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for mobile marketing, the method comprising:
in a mobile marketing device:
redeeming at a point of sales, one or more coupons that are received by a user device;
verifying said redeemed one or more coupons based on a generated secure unique code corresponding to each of said redeemed one or more coupons; and
scheduling payment associated with a monetary value of each of said redeemed one or more coupons based on said verification.

2. The method according to claim 1, comprising generating one or more of said secure unique codes for each of said coupons received from a manufacturer by said mobile marketing device.

3. The method according to claim 2, comprising storing one or more of: said received coupons from said manufacturer, said generated one or more secure unique codes corresponding to each of said received coupons from said manufacturer, and/or a user's credentials.

4. The method according to claim 3, comprising verifying said stored said user's credentials prior to communicating said one or more coupons from said mobile marketing device to said user device.

5. The method according to claim 4, comprising communicating said one or more coupons to said user device via a mobile application based on said verification of said stored said user's credentials.

6. The method according to claim 3, comprising communicating said stored said generated one or more secure unique codes corresponding to each of said coupons received from said manufacturer to a retailer associated with said point of sales.

7. The method according to claim 6, wherein said retailer is operable to associate said redeemed one or more coupons with a corresponding one of said communicated said stored said generated one or more secure unique codes.

8. The method according to claim 1, comprising managing delivery of said one or more coupons to said user device based on one or more of: a number of said one or more coupons redeemed, an expiration date of said one or more coupons, and/or a number of said generated one or more secure unique codes entered at said user device.

9. A non-transitory machine-readable storage having stored thereon, a computer program having at least one code section for mobile marketing, the at least one code section being executable by a machine for causing the machine to perform steps comprising:
in a mobile marketing device:
redeeming at a point of sales, one or more coupons that are received by a user device;
verifying said redeemed one or more coupons based on a generated secure unique code corresponding to each of said redeemed one or more coupons; and
scheduling payment associated with a monetary value of each of said redeemed one or more coupons based on said verification.

10. The non-transitory machine-readable storage according to claim 9, wherein said at least one code section comprises code for generating one or more of said secure unique codes for each of said coupons received from a manufacturer by said mobile marketing device.

11. The non-transitory machine-readable storage according to claim 10, wherein said at least one code section comprises code for storing one or more of: said received coupons from said manufacturer, said generated one or more secure unique codes corresponding to each of said received coupons from said manufacturer, and/or a user's credentials.

12. The non-transitory machine-readable storage according to claim 11, wherein said at least one code section comprises code for verifying said stored said user's credentials prior to communicating said one or more coupons from said mobile marketing device to said user device.

13. The non-transitory machine-readable storage according to claim 12, wherein said at least one code section comprises code for communicating said one or more coupons to said user device via a mobile application based on said verification of said stored said user's credentials.

14. The non-transitory machine-readable storage according to claim 11, wherein said at least one code section comprises code for communicating said stored said generated one or more secure unique codes corresponding to each of said coupons received from said manufacturer to a retailer associated with said point of sales.

15. The non-transitory machine-readable storage according to claim 14, wherein said retailer is operable to associate said redeemed one or more coupons with a corresponding one of said communicated said stored said generated one or more secure unique codes.

16. The non-transitory machine-readable storage according to claim 9, wherein said at least one code section comprises code for managing delivery of said one or more coupons to said user device based on one or more of: a number of said one or more coupons redeemed, an expiration date of said one or more coupons, and/or a number of said generated one or more secure unique codes entered at said user device.

17. A system for mobile marketing, the system comprising:
one or more processors and/or circuits for use in a mobile marketing device, said one or more processors and/or circuits being operable to:
redeem at a point of sales, one or more coupons that are received by a user device;
verify said redeemed one or more coupons based on a generated secure unique code corresponding to each of said redeemed one or more coupons; and
schedule payment associated with a monetary value of each of said redeemed one or more coupons based on said verification.

18. The system according to claim 17, wherein said one or more processors and/or circuits are operable to generate one or more of said secure unique code for each of said coupons received from a manufacturer by said mobile marketing device.

19. The system according to claim 18, wherein said one or more processors and/or circuits are operable to store one or more of: said received coupons from said manufacturer, said generated one or more secure unique codes corresponding to each of said received coupons from said manufacturer, and/or a user's credentials.

20. The system according to claim 19, wherein said one or more processors and/or circuits are operable to verify said stored said user's credentials prior to communicating said one or more coupons from said mobile marketing device to said user device.

21. The system according to claim 20, wherein said one or more processors and/or circuits are operable to communicate said one or more coupons to said user device via a mobile application based on said verification of said stored said user's credentials.

22. The system according to claim 19, wherein said one or more processors and/or circuits are operable to communicate said stored said generated one or more secure unique codes corresponding to each of said coupons received from said manufacturer to a retailer associated with said point of sales.

23. The system according to claim 22, wherein said retailer is operable to associate said redeemed one or more coupons with a corresponding one of said communicated said stored said generated one or more secure unique codes.

24. The system according to claim 17, wherein said one or more processors and/or circuits are operable to manage delivery of said one or more coupons to said user device based on one or more of: a number of said one or more coupons redeemed, an expiration date of said one or more coupons, and/or a number of said generated one or more secure unique codes entered at said user device.
